(19) United States
(12) Patent Application Publication
(10) Pub. No.: US 2018/0134215 A1
(43) Pub. Date: May 17, 2018

(54) METHOD AND DEVICE FOR GENERATING DRIVING ASSISTANCE INFORMATION

(71) Applicant: SAMSUNG ELECTRONICS CO., LTD., Suwon-si (KR)

(72) Inventors: Gye-hyun KIM, Seoul (KR); Tae-hyeong KIM, Seoul (KR); Chee-hoon LEE, Incheon (KR); Yong-woo LEE, Seoul (KR)

(21) Appl. No.: 15/698,941

(22) Filed: Sep. 8, 2017

Related U.S. Application Data
(60) Provisional application No. 62/422,687, filed on Nov. 16, 2016.

(30) Foreign Application Priority Data
Mar. 2, 2017 (KR) 10-2017-0027329

(51) Int. Cl. B60Q 9/00; G07C 5/08

(52) U.S. Cl. CPC B60Q 9/00; G07C 5/0808

(57) ABSTRACT

A method of generating running assistance information includes recognizing a running pattern of a vehicle based on information about a current state of the vehicle which is sensed while the vehicle is running; determining a current status of a driver of the vehicle based on the running pattern of the vehicle; and generating a notification signal based on a risk level of the driver determined based on the determined current status of the driver.

### CROSS-REFERENCE TO RELATED APPLICATIONS

This application is based on and claims priority under 35 U.S.C. § 119 to U.S. Patent Application No. 62/422,687, filed on Nov. 16, 2016, in the US Patent and Trademark Office and Korean Patent Application No. 10-2017-0027329, filed on Mar. 2, 2017, in the Korean Intellectual Property Office, the disclosures of which are incorporated by reference herein in their entireties.

### BACKGROUND

### 1. Field

The present disclosure relates generally to a method and device for generating driving assistance information, and for example, to a method and device for generating a notification signal based on a risk level of a driver.

### 2. Description of Related Art

As technologies applied to vehicles have become more advanced, various methods of recognizing a running pattern of the vehicle have been developed.

Meanwhile, when it is difficult to determine the running pattern of the vehicle due to reasons such as a change in road conditions, different driving habits of drivers, etc., there is an increase in demand for technology capable of more accurately determining the running pattern of the vehicle and determining a state of a driver, based on a limited amount of data, and providing the user with a notification.

### SUMMARY

Methods and devices for generating driving assistance information are provided. Non-transitory computer readable recording media having embodied thereon computer programs for executing the methods are also provided.

Additional example aspects will be set forth in part in the disclosure which follows and, in part, will be apparent from the disclosure.

According to an aspect of an example embodiment, a device includes a sensing unit comprising sensing circuitry configured to sense a current state of a vehicle while the vehicle is running; and a controller configured to recognize a running pattern of the vehicle based on information obtained by the sensing unit, to determine a current status of a driver of the vehicle based on the running pattern of the vehicle, and to generate a notification signal based on a risk level of the driver determined based on the determined current status of the driver.

According to an aspect of another example embodiment, a method of generating running assistance information includes recognizing a running pattern of a vehicle based on information about a current state of the vehicle which is sensed while the vehicle is running; determining a current status of a driver of the vehicle based on the running pattern of the vehicle; and generating a notification signal based on a risk level of the driver determined based on the determined current status of the driver.

According to an aspect of another example embodiment, a non-transitory computer readable recording medium having embodied thereon a computer program for executing the method is provided.

### BRIEF DESCRIPTION OF THE DRAWINGS

These and/or other aspects, features and attendant advantages will become apparent and more readily appreciated from the following detailed description, taken in conjunction with the accompanying drawings, in which like reference numerals refer to like elements, and wherein:

FIG. 1 is a diagram illustrating an example of determining a status of a driver, according to an example embodiment;

FIG. 2 is a flowchart illustrating an example method of generating notification information, according to an example embodiment;

FIG. 3 is a diagram illustrating an example of determining whether a vehicle is running on a highway, according to an example embodiment;

FIG. 4 is a diagram illustrating an example of recognizing a running pattern of a vehicle, according to an example embodiment;

FIG. 5 is a diagram illustrating an example of determining a risk level of a driver, according to an example embodiment;

FIG. 6 is a diagram illustrating an example of outputting a notification signal, according to an example embodiment;

FIG. 7 is a diagram illustrating an example of outputting a notification signal, according to an example embodiment;

FIGS. 8A, 8B, 8C and 8D are diagrams illustrating an example of an application execution screen according to an example embodiment;

FIGS. 9 and 10 are block diagrams illustrating an example device according to various example embodiments;

FIG. 11 is a block diagram illustrating an example controller according to an example embodiment;

FIG. 12 is a block diagram illustrating an example data learning unit according to an example embodiment;

FIG. 13 is a block diagram illustrating an example data recognition unit according to an example embodiment; and

FIG. 14 is a diagram illustrating an example in which a device and a server are synchronized with each other and learn and recognize data, according to an example embodiment.

### DETAILED DESCRIPTION

The present disclosure will now be described in greater detail with reference to the accompanying drawings, in which various example embodiments of the present disclosure are illustrated. The present disclosure may, however, be embodied in many different forms and should not be construed as being limited to the embodiments set forth herein; rather, these embodiments are provided so that this disclosure will be thorough and complete, and will fully convey the concept of the present disclosure to those of ordinary skill in the art. Like reference numerals in the drawings denote like elements.

Throughout the disclosure, it will be understood that when an element or layer is “connected to” another element or layer, the element or layer may be “directly connected to” another element or may be “electrically connected” thereto with an intervening element or layer therebetween. When a portion “includes” an element, another element may be further included, rather than excluding the existence of the other element, unless otherwise described.

In the present disclosure, a user input may include at least one of, for example, and without limitation, a touch input, a bending input, a voice input, a key input, and a multimodal input but is not limited thereto. Hereinafter, the present disclosure will be described in greater detail by explaining various example embodiments of the present disclosure with reference to the attached drawings.

In the present disclosure, an application may refer, for example, to a series of computer programs set to perform a specific job. The application described in the present disclosure may vary. For example, the application may include, without limitation, a web browser, a camera application, a data transfer application, a music play application, a moving image play application, an email application, a navigation application, a map application, and a driving related application but is not limited thereto.

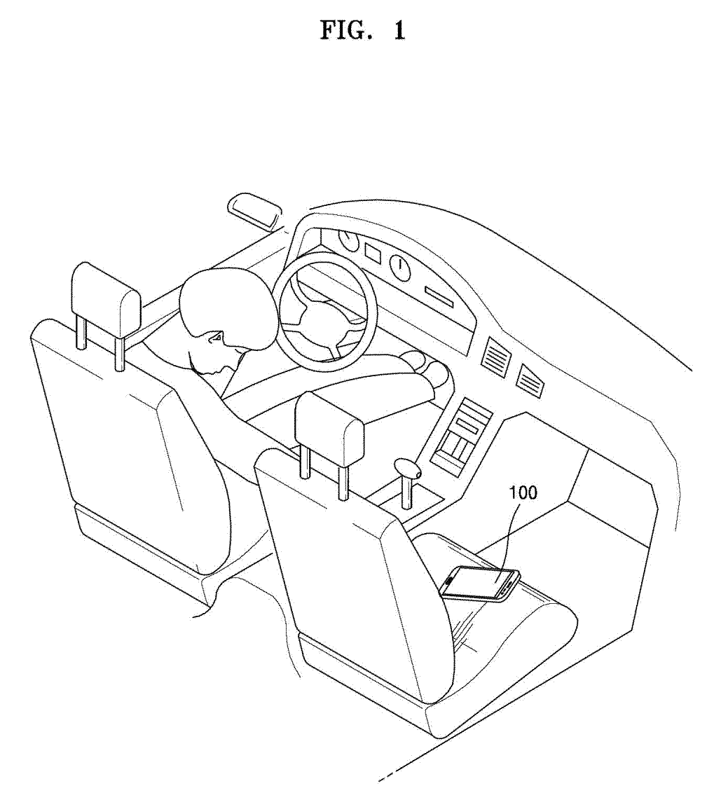

FIG. 1 is a diagram illustrating an example of determining a status of a driver, according to an example embodiment.

Referring to FIG. 1, a device 100 may use information generated during running of a vehicle to determine a status of a driver. In an embodiment, if it is determined that a current status of the driver needs to be determined, such as when the driver drives while drowsy, the device 100 may provide the driver with a notification to induce safe driving. For example, the device 100 may determine whether the vehicle is running on a predetermined road (e.g., a highway). If it is determined that the vehicle is running on the predetermined road, the device 100 may determine a risk level of the driver. The device 100 may output a notification for inducing safe driving if the risk level of the driver is high.

The information generated during running of the vehicle may include, for example, and without limitation, at least one of information about a current state of the vehicle which is sensed while the vehicle is running, status information of the driver, state information of the device 100, and peripheral environment information of the device 100 but is not limited thereto.

The information about the current state of the vehicle which is sensed while the vehicle is running may be information about the vehicle obtained by a sensing unit of the device 100, such as location information of the vehicle, acceleration information of the vehicle, speed information of the vehicle, speed maintenance time information of the vehicle, rotation information of the vehicle, and the like but is not limited thereto.

The status information of the driver may include, for example, and without limitation, information about a motion of the driver who is driving the vehicle and may include information about a concentration status of the driver, a drowsiness status of the driver, a status of the driver who is on the phone, etc. and biometric information of the user but is not limited thereto.

The status information of the device 100 may include, for example, and without limitation, location information of the device 100, time information, activation information of a communication module (e.g., Wi-Fi ON/Bluetooth OFF/GPS ON/NFC ON, etc.), connection status information of the device 100, application information executed in the device 100 (e.g., application identification information, an application type, application usage time, a application usage period), and the like but is not limited thereto.

The peripheral environment information of the device 100 may refer, for example, and without limitation, to environment information within a predetermined radius from the device 100 and may include, for example, and without limitation, weather information, temperature information, humidity information, illuminance information, noise information, sound information, and the like but is not limited thereto.

The device 100 may, for example, and without limitation, be a smart phone, a personal computer (PC), a tablet PC, a smart television (TV), a mobile phone, a personal digital assistant (PDA), a laptop, a media player, a micro server, navigation, a kiosk, a MP3 player, a digital camera, a consumer electronics device, and another mobile or non-mobile computing device but is not limited thereto. In addition, the device 100 may be a wearable device, such as a watch, a pair of glasses, a hair band, and a ring having a communication function and a data processing function but is not limited thereto. The device 100 may include all sorts of devices that may determine the risk level of the driver and provide a notification signal to the driver.

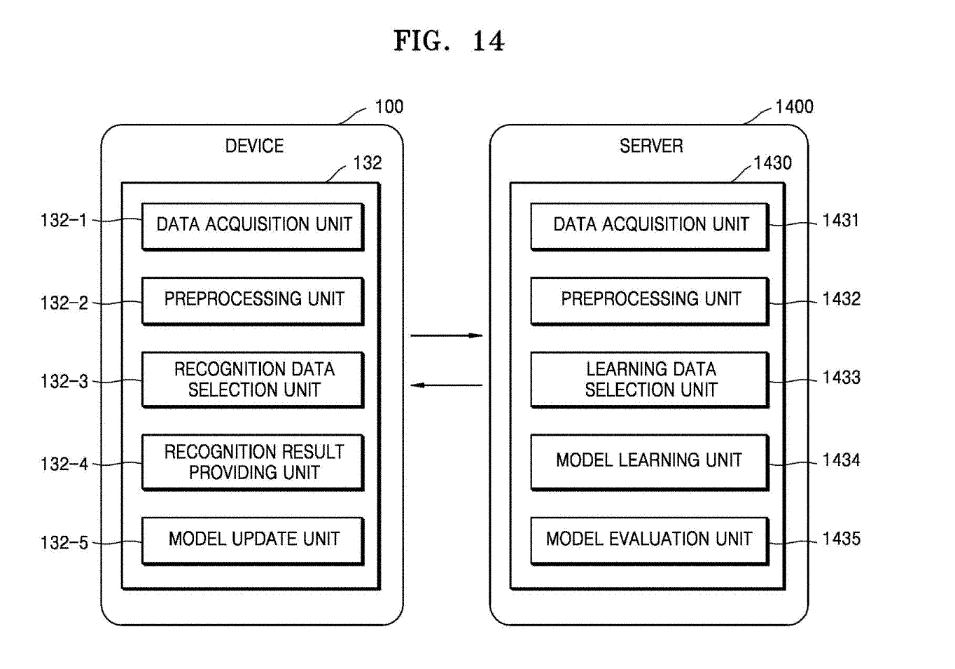

In addition, the device 100 may communicate with a server 1400 (as illustrated, for example, in FIG. 14) and an external device (not shown) through a predetermined network, in order to utilize information generated during running of various vehicles. In this case, the network may include a local area network (LAN), a wide area network (WAN), a value added network (VAN), a mobile radio communication network, a satellite communication network, and a correlation combination thereof, may be a data communication network having a comprehensive meaning for allowing each network constituent to communicate smoothly with each other, and may include a wired Internet, a wireless Internet, and a mobile wireless communication network. The wireless communication may be, for example, Wi-Fi, Bluetooth, Bluetooth low energy, ZigBee, Wi-Fi Direct (WFD), ultra wideband (UWB), infrared data association (IrDA), near field communication (NFC), and the like but is not limited thereto.

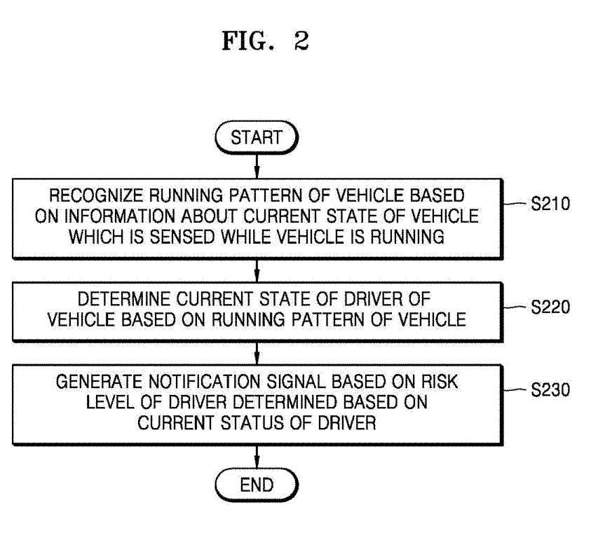

FIG. 2 is a flowchart illustrating an example method of generating notification information, according to an example embodiment.

In operation S210, the device 100 may recognize a running pattern of a vehicle based on information about a current state of the vehicle which is sensed while the vehicle is running.

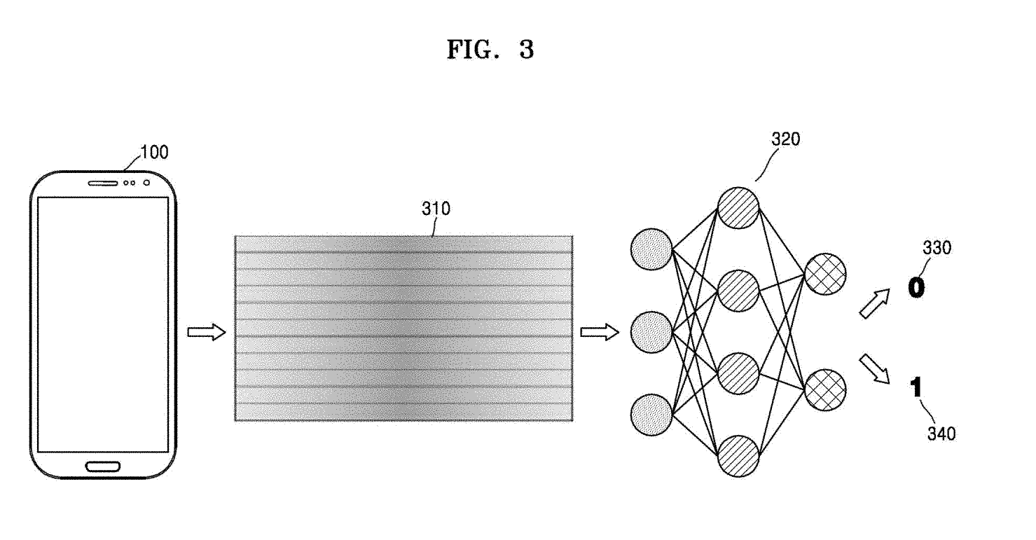

In an embodiment, prior to operation S210, the device 100 may intermittently obtain the information about the current state of the vehicle which is sensed while the vehicle is running, thereby recognizing a running pattern of the vehicle. For example, the device 100 may obtain the information about the current state of the vehicle which is sensed while the vehicle is running at intervals of one minute. In addition, the device 100 may determine whether the vehicle is running on a highway, based on the running pattern of the vehicle. The operation of determining whether the vehicle is running on the highway may be always performed in the device 100. An example of determining whether the vehicle is running on the highway will be described in greater detail below with reference to FIG. 3.

In an embodiment, an application for safe driving may be activated automatically if it is determined that the vehicle is running on the highway. For example, after a notification window that the application is activated is displayed on a screen of the device 100, a home screen of the application may be automatically displayed. If the application is activated, the device 100 may constantly obtain the information about the current state of the vehicle which is sensed while the vehicle is running. For example, the device 100 may obtain the information about the current state of the vehicle which is sensed while the vehicle is running at intervals of one second.

In an embodiment, the information about the current state of the vehicle which is sensed while the vehicle is running may be obtained through a sensing unit of the device 100. Further, in order to recognize the running pattern of the vehicle, which vehicle relates to the information about the current state of the vehicle which is sensed while the vehicle is running may be determined according to learning based on a preset reference. For example, supervised learning in which information about a current state of a predetermined vehicle which is sensed while the predetermined vehicle is running and a running pattern of the vehicle in a predetermined dangerous driving situation are used as input values and unsupervised learning for finding the running pattern of the vehicle by learning a type of the information about the current state of the vehicle which is sensed while the vehicle is running, which is necessary for determining the running pattern of the vehicle without any guide, may be used for recognizing the running pattern of the vehicle. Also, for example, reinforcement learning using feedback about whether a result of recognition of the running pattern of the vehicle according to learning is correct may be used for recognition of the running pattern of the vehicle.

In an embodiment, the device 100 may recognize the running pattern of the vehicle based on the information obtained from sensing as the vehicle runs on the highway. For example, the running pattern of the vehicle may include dangerous driving and safe driving. The dangerous driving may include erratic driving that repeats movement of a steering wheel of the vehicle from left to right and rotates the steering wheel more than a predetermined range, violent driving, speeding driving, lane violation, sudden stopping, sudden acceleration, sudden lane changing, and reverse driving, etc.

In an embodiment, the device 100 may recognize the running pattern of the vehicle based on the information sensed by the device 100 located in the vehicle. For example, regardless of where the device 100 is located in the vehicle, the device 100 may learn the position where it is placed, so that the device 100 may recognize the running pattern of the vehicle. For example, even if the device 100 is located in a bag containing the driver's clothes, a cup holder located in the vehicle, a mount for the device 100 located in the vehicle, a passenger seat of the vehicle, etc., the device 100 may obtain the information about the current state of the vehicle which is sensed while the vehicle is running irrespective of the position of the device 100.

In operation S220, the device 100 may determine a current status of the driver of the vehicle based on the running pattern of the vehicle.

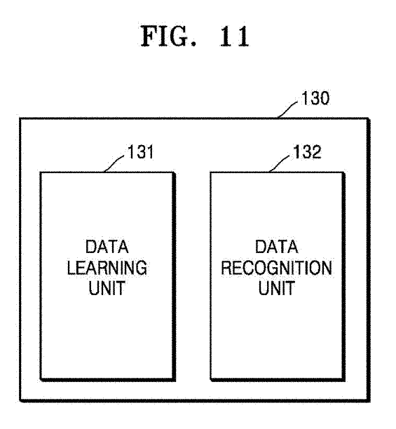

In an embodiment, the device 100 may determine the current status of the driver corresponding to the running pattern according to a model generated by learning. The model generated by learning may be used for the device 100 to determine a risk level of the driver. For example, the model generated by learning may be a data recognition model that will be described later in FIGS. 11 through 14. For example, the device 100 may determine that the driver is in a dangerous state if the vehicle has been driven dangerously. As an example, if the device 100 recognizes that the vehicle shows a running pattern that crosses a lane in which the vehicle is running, the device 100 may determine that the vehicle has been driven dangerously. At this time, the device 100 may determine that the driver is drowsy. As another example, when the device 100 recognizes that the vehicle shows a running pattern in which the vehicle repeatedly accelerates and abruptly stops, the device 100 may determine that the vehicle has been driven dangerously. At this time, the device 100 may determine that the driver is currently in a careless state. For example, the careless state may include a state in which the driver is not looking forward and a state in which the driver operates a module installed in the device 100 or the vehicle, etc.

In operation S230, the device 100 may generate a notification signal based on the risk level of the driver determined based on the current status of the driver.

In an embodiment, the device 100 may determine the risk level of the driver according to the current status of the driver.

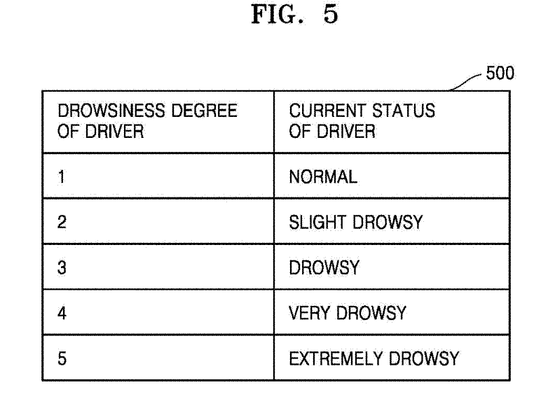

In an embodiment, the device 100 may generate the notification signal when the risk level of the driver is greater than or equal to a threshold value. In an embodiment, the risk level of the driver may be expressed in terms of a numerical value, and the higher the value, the higher the risk level. For example, the risk level may be represented by an integer from 1 to 7, and the device 100 may be preset to generate the notification signal when the risk level is four or more. In an embodiment, by using a preset table, the risk level of the driver may be determined according to the current status of the driver. An example of determining the risk level of the driver using the preset table will be described in greater detail below with reference to FIG. 5.

Further, in an embodiment, the device 100 may further determine the risk level of the driver in consideration of at least one of the information obtained from the vehicle and biometric information of the user obtained from another device of the driver. For example, the information obtained from the vehicle may include atmospheric information (e.g., information about carbon dioxide concentration in the vehicle), image information generated from a camera included in the vehicle, on-board diagnostics (OBD) (e.g., angle information of the steering wheel, RPM information, etc.), and the like. Also, for example, another device of the driver may include a wearable device such as a smart watch that is worn on a driver's wrist. For example, the biometric information of the driver may include information on the driver's heart rate, electrocardiogram, skin resistance, and the like.

In an embodiment, the device 100 may output the generated notification signal from the device 100. Further, in an embodiment, the device 100 may transmit the generated notification signal to an external device to operate the external device. For example, the device 100 may transmit a request to output a notification signal from a module installed in the vehicle to a module installed in the vehicle. The notification signal may include at least one of a sound, image, and vibration.

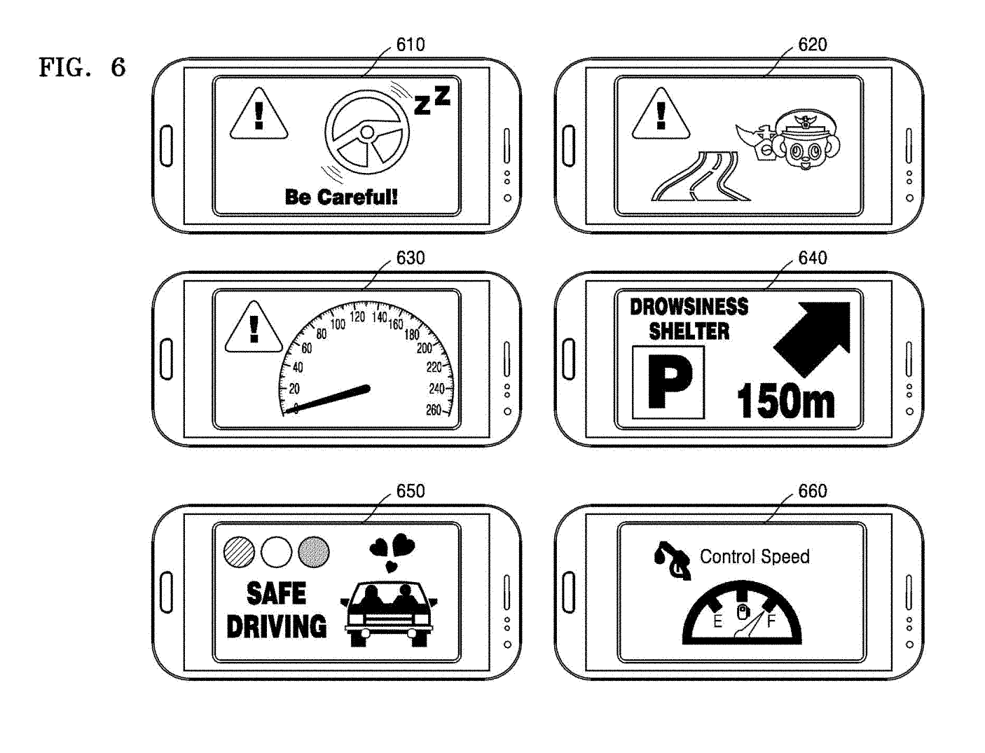

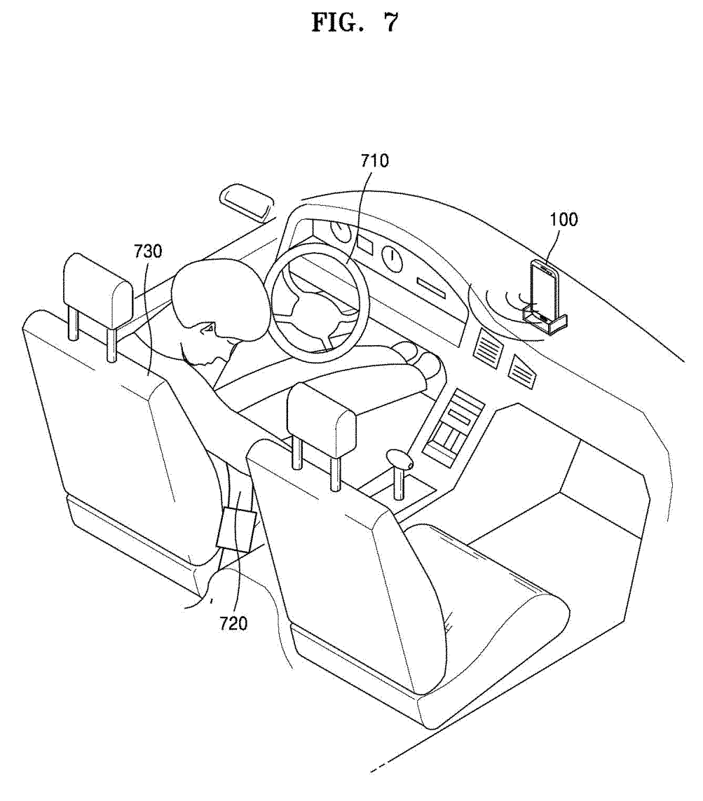

An example of outputting the notification signal will be described in greater detail below with reference to FIGS. 6 and 7.

FIG. 3 is a diagram illustrating an example of determining whether a vehicle is running on a highway, according to an example embodiment.

Referring to FIG. 3, the device 100 may determine whether the vehicle is running on the highway, based on information about a current state of the vehicle which is sensed while the vehicle is running.

In an embodiment, the information about a current state of the vehicle which is sensed while the vehicle is running may include latitude and longitude information of a GPS sensor, x, y, z axis information (accel x, accel y, accel z) of an acceleration sensor, x, y, and z axis information (gyro x, gyro y, and gyro z) of a gyroscope sensor, and x, y, and z axis information (linear accel x, linear accel, and linear accel z) in which x, y, and z axis information of a gravity sensor is corrected in the x, y, z axis information of the acceleration sensor. For example, accel x, accel y, accel z, gyro x, gyro y, gyro z, linear accel x, linear accel y, and linear accel z may be obtained through data obtained by the acceleration sensor, the gyro sensor, and the gravity sensor of the device 100. Alternatively, accel x, accel y, accel z, gyro x, gyro y, gyro z, linear accel x, linear accel y, and linear accel z may also be obtained via an inertial measurement unit (IMU) sensor of the device 100.

Further, in order to determine whether the vehicle is running on a highway, which vehicle relates to the information about the current state of the vehicle which is sensed while the vehicle is running may be determined according to learning based on a preset reference. For example, supervised learning in which predetermined brain wave information of a driver and information about a current state of a predetermined vehicle which is sensed during running of the predetermined vehicle are used as input values and unsupervised learning that finds a pattern for determining whether the vehicle is traveling on a highway by self learning a type of information necessary for determining whether the vehicle is running on the highway without any guidance may be used to determine whether or not the vehicle is running on the highway. Further, for example, reinforcement learning that uses feedback about whether a result of determining whether or not the vehicle is running on the highway based on learning is correct may be used to determine whether or not the vehicle is running on the highway.

In an embodiment, the information that the current state of the vehicle is sensed while the vehicle is running may be a time series signal. Further, the information about the current state of the vehicle which is sensed while the vehicle is running may be processed in a form suitable for learning. In an embodiment, the device 100 may perform an operation of dividing the time series signal into an appropriate length of time. For example, the appropriate length of time may be a length including a specific running pattern. In addition, the appropriate length of time may be set to a predetermined length that shows an optimal performance obtained through experimentation. For example, a predetermined length that shows the optimal performance obtained through experimentation may be set by a manufacturer of an application for safe driving. Also, a user may change settings even after the predetermined length is set by the manufacturer of the application.

In an embodiment, an input value of a data recognition model 320 for determining whether the vehicle is running on the highway may be an input image 310 generated by imaging 11 signals of latitude information, longitude information, accel x, accel y, accel z, gyro x, gyro y, gyro z, X, linear accel y, and linear accel z. For example, the device 100 may generate the input image 310 through imaging of a signal. Here, the imaging of the signal may be an operation of generating the input image 310 in which each of the 11 signals is a row of the input image 310.

In an embodiment, when the input image 310 is input to the data recognition model 320, 0 (330) or 1 (340) may be output. For example, 0 (330) may be a value indicating that the vehicle is not running on the highway, and 1 (340) may be a value indicating that the vehicle is running on the highway. In an embodiment, even when it is difficult to determine a running pattern due to road conditions and driving habits of the driver, the device 100 may learn a reference for determining whether the vehicle is running on the highway, thereby more accurately determining whether the vehicle is running on the highway. Also, without additional equipment and map data, it may be difficult to automatically recognize whether the vehicle is running on the highway by recognizing the running pattern of the vehicle by using only a sensing unit of the device 100 held by the driver.

Alternatively, in an embodiment, it may be determined whether the vehicle is running on the highway by using a rule-based method that uses a running speed of the vehicle and a holding time of the running speed of the vehicle, rather than a learning method of the device 100. For example, the device 100 may assign different weights to the running speed of the vehicle and the holding time of the running speed of the vehicle and may determine whether the vehicle is running on the highway through a mapping function.

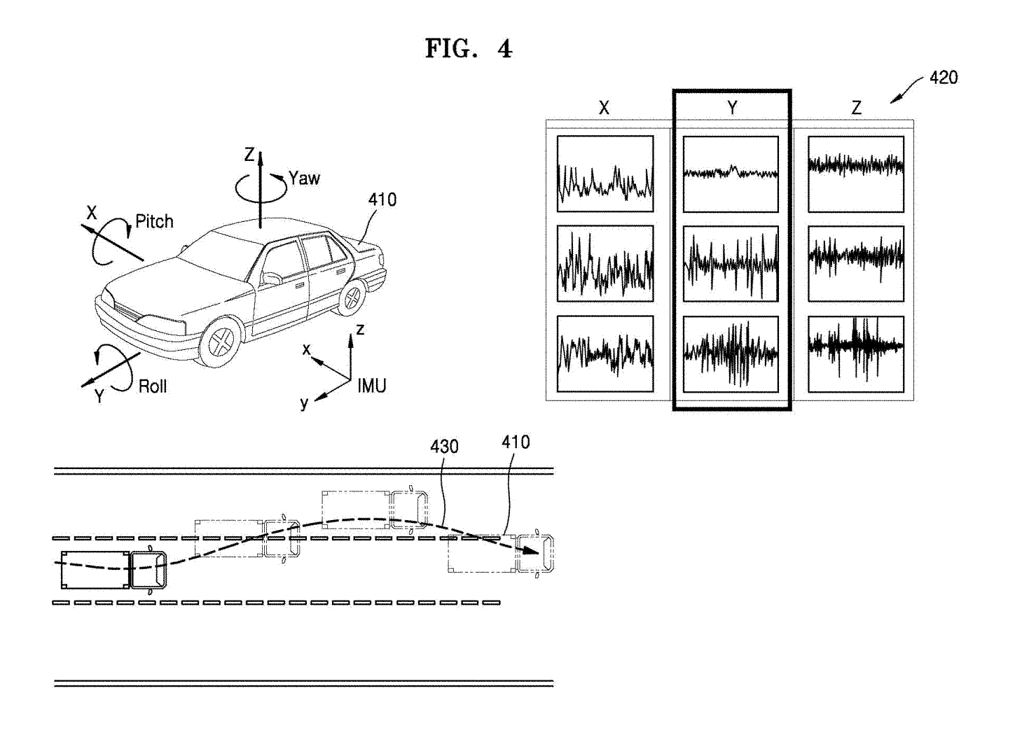

FIG. 4 is a diagram illustrating an example of recognizing a running pattern of a vehicle 410, according to an example embodiment.

Referring to FIG. 4, the device 100 may recognize the running pattern of the vehicle 410 using information about a current state of the vehicle 410 which is sensed while the vehicle 410 is running. In an embodiment, the running pattern of the vehicle 410 may be recognized using sensing data 420 of the vehicle 410 that the IMU sensor of the device 100 senses. The sensing data 420 that the IMU sensor of the device 100 senses may be comprise x, y, and z axes data of the vehicle 410. For example, the x, y and z axes of the IMU sensor of the device 100 may correspond to x, y and z axes of the vehicle 410, the x axis may be a right direction of the vehicle 410, and the z-axis may indicate an upward direction of the vehicle 410. For example, the sensing data 420 of the IMU sensor may be data according to a time-series flow, and a y-axis value may increase over time. For example, an increase in the y-axis value of the sensing data 420 of the IMU sensor may mean a running pattern 430 of the vehicle 410 swaying in left and right directions. In an embodiment, when comparing the running pattern 430 of the vehicle 410 with a normal running pattern during safe running, abnormal patterns that may not be found in safe running may appear in the running pattern 430 of the vehicle 410. As described above, in an embodiment, the device 100 may determine a current status of a user by recognizing the running pattern at the time of dangerous driving.

FIG. 5 is a diagram illustrating an example of determining a risk level of a driver, according to an example embodiment.

Referring to FIG. 5, a table 500 may include a current status of the driver for determining the risk level of the driver. In an embodiment, the risk level of the driver may include, but is not limited to, a drowsiness degree of the driver and a careless driving degree of the driver. The content included in the table 500 according to one embodiment may be set and changed based on learning according to a predetermined reference.

As illustrated in FIG. 5, for example, if the device 100 determines that the driver is currently in a completely alert normal state, the device 100 may use the table 500 to determine that the drowsiness degree of the driver is 1. Also, for example, if the device 100 determines that the driver is currently in a very drowsy state, takes a lot of effort to overcome the drowsiness, and is fighting the drowsiness, the device 100 may use the table 500 to determine that the drowsiness degree of the driver is 4. For example, the drowsiness degree of the driver of the table 500 may be set to 3 as a threshold value. When the drowsiness degree of the driver of the table 500 is set to 3 as the threshold value, the device 100 may output a notification signal if the device 100 determines that the drowsiness degree of the driver is from 3 to 5.

FIG. 6 is a diagram illustrating an example of outputting a notification signal, according to an example embodiment.

Referring to FIG. 6, the device 100 may output the notification signal as an image. In an embodiment, the device 100 may display a pop-up window that warns of dangerous driving or induces safe driving on the screen of the device 100.

In an embodiment, if the device 100 determines that the driver is driving erratically and a drowsiness degree of the driver is greater than or equal to a threshold value, the device 100 may display an indication of movement of a steering wheel of a vehicle and a first image 610 including a drowsiness indication of the driver such as “ZZZ” and a phrase “Be Careful!” to warn the driver of drowsy driving. Also, for example, the device 100 may display a fourth image 640 that guides the driver to a parking spot 150 meters away in an upper right direction to take a rest.

In an embodiment, if the device 100 determines that the driver is driving under the influence, the device 100 may display a second image 620 informing the driver that the police are checking drunken drivers ahead. Also, for example, the device 100 may display a fifth image 650 that induces safe driving.

In an embodiment, if the device 100 determines that the driver is driving over a speed limit, the device 100 may display a third image 630 that includes a speed gauge and warns the driver that the driver is driving over the speed limit, or a sixth image 660 that includes a phrase “ Control Speed ” and guides the driver to slow down.

FIG. 7 is a diagram illustrating an example of outputting a notification signal according to an example embodiment.

Referring to FIG. 7, in an embodiment, the device 100 may generate the notification signal with sound and/or vibration and output the generated notification signal from the device 100. For example, the device 100 may provide a driver with a warning sound to notify dangerous driving or a guidance sound to induce safe driving. For example, the guidance sound may be a voice to encourage stretching, a voice to explain a method of resolving drowsiness, and a voice to guide the driver to a resting place or a parking spot.

In an embodiment, the device 100 may transmit the generated notification signal to a module installed in a vehicle, in order to operate the module installed in the vehicle. For example, the module installed in the vehicle may output a notification signal by receiving a request to output the notification signal from the device 100.

In an embodiment, the module installed in the vehicle may include, but is not limited to, a steering wheel 710, a seat belt 720, a chair 730 of a driver's seat, and a window of a vehicle. For example, if the device 100 determines that a risk level of the driver is more than a threshold value, the device 100 may transmit a vibration signal to the steering wheel 710, the seat belt 720, and/or the chair 730 of the driver's seat so that the steering wheel 710, the seatbelt 720 and/or the chair 730 of the driver's seat may output vibration. It may prevent accidents by notifying the driver about his or her dangerous driving through the output vibration of the module installed in the vehicle.

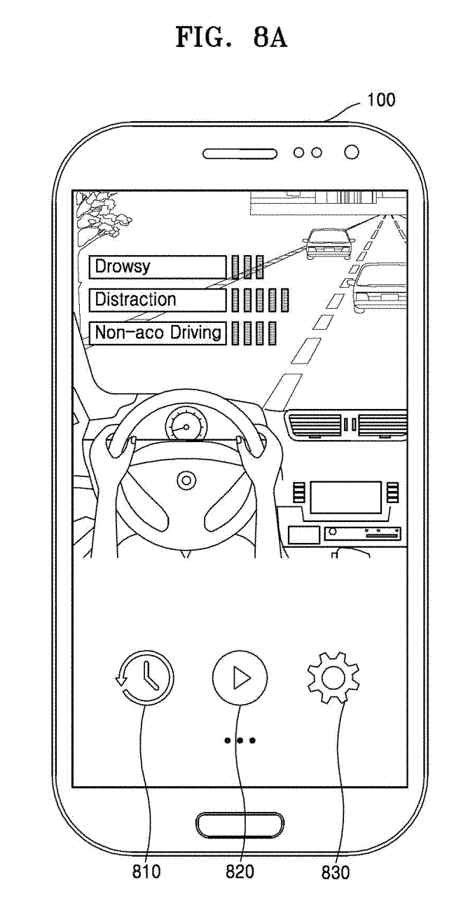

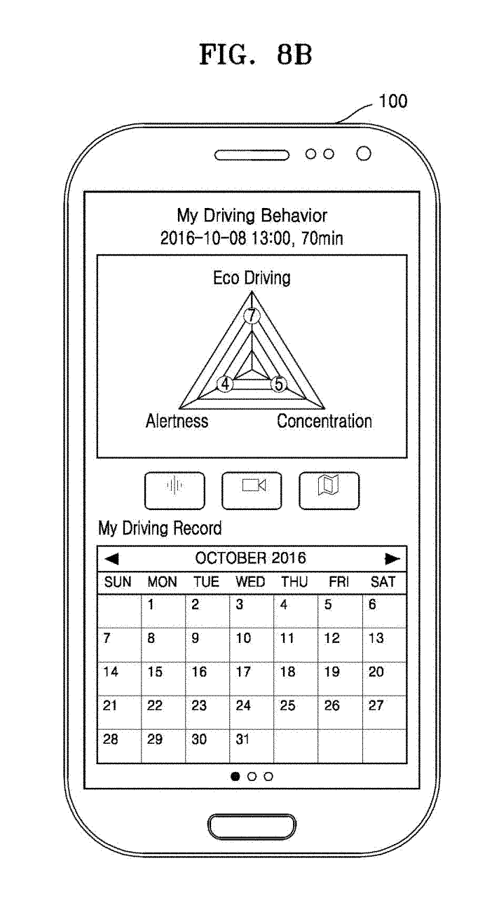

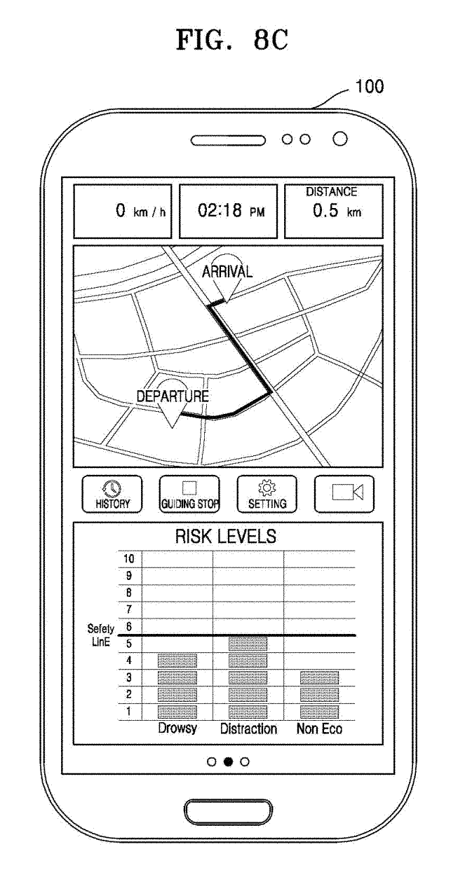

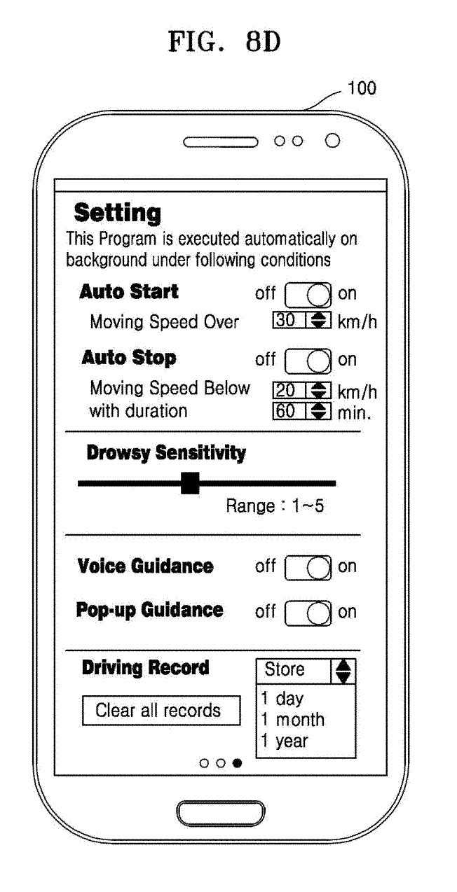

FIGS. 8A, 8B, 8C and 8D are diagrams illustrating an example of an application execution screen according to an example embodiment.

FIG. 8A is a diagram illustrating an example of a home screen of an application for safe operation.

In an embodiment, the home screen of the application for safe driving may be a screen when the application is automatically activated when the device 100 determines that a vehicle is driving on a highway. Alternatively, the home screen may be a screen when the device 100 receives a user input and executes the application. For example, the device 100 may include objects for performing a specific operation in the home screen of the application for safe driving. For example, the device 100 may include a first icon 810 for displaying preset running history information in the home screen. For example, when the device 100 receives a user input for selecting the first icon 810, the device 100 may move to a screen illustrated in FIG. 8B. In addition, for example, the device 100 may continuously obtain information generated during running of the vehicle and include a second icon 820 in the home screen for determining a dangerous driving degree of the driver. For example, when the device 100 receives a user input for selecting the second icon 820, the device 100 may move to a screen illustrated in FIG. 8C. Also, for example, the device 100 may include a third icon 830 for changing settings of the application in the home screen. For example, when the device 100 receives a user input for selecting the third icon 830, the device 100 may move to a screen illustrated in FIG. 8D.

FIGS. 8B and 8C are diagrams showing the running history information of the vehicle included in the application for safe driving.

Referring to FIG. 8B, in an embodiment, the device 100 may display running history information of the vehicle recorded during running of the vehicle, in the form of a calendar or a list. For example, based on the number of times the vehicle was driven on a particular date, an image of the vehicle may be displayed on a corresponding date. In addition, in an embodiment, when the device 100 receives a user input for selecting a predetermined date, the device 100 may represent running history information of the vehicle of a corresponding date through an eco driving item, a driver alertness item, and a driver concentration item. For example, when the device 100 receives a user input that continuously touches a predetermined date, the device 100 may move to a screen shown in FIG. 8C. For example, if the device 100 receives an input whereby October 8th is tapped in a calendar, the device 100 may display eco driving, driver alertness, and driver concentration of October 8th, and, if the device 100 receives an input whereby October 8th is double-tapped in the calendar, the device 100 may move to a screen that shows only running history information of October 8th in detail, as illustrated in FIG. 8C.

Referring to FIG. 8C, running history information corresponding to a date selected by the user is shown. For example, map data may be used to display a route the driver has driven. Further, for example, a graph may be displayed in which drowsy driving of the driver, distracted driving, and non-eco driving are quantified. For example, the device 100 determines that the number of times rapid acceleration and rapid braking occurs is large, driving efficiency is reduced, and thus non-eco driving may be increased. The device 100 may display the running history information after the driver has finished driving, and thus, the driver may improve his/her dangerous driving habit.

FIG. 8D is a diagram illustrating an example of a setting screen of an application for safe operation. In an embodiment, a user of the device 100 may change settings of the application. For example, the user may set the application to be automatically activated when a running speed of the vehicle is 30 km/h or more. Also, for example, the user may set the application to be inactivated if the running speed of the vehicle lasts for more than 60 minutes at less than 20 km/h. In addition, for example, the user may adjust sensitivity with respect to drowsy driving as well as set on/off of a notification signal. Also, for example, the user may select how long to keep running history information. For example, the user may store running history information on a daily, weekly, or yearly basis, or may not store the running history information.

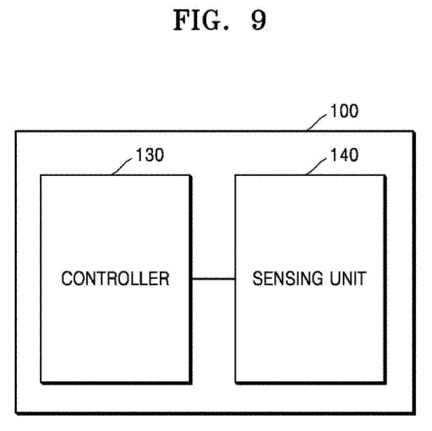

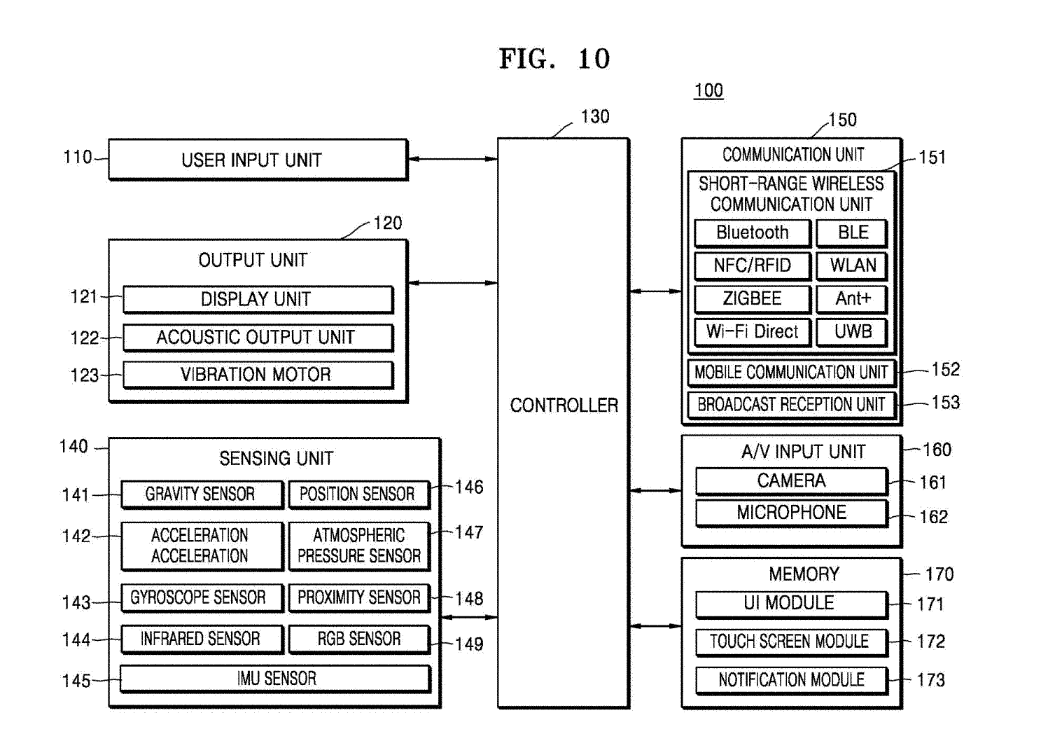

FIGS. 9 and 10 are block diagrams illustrating an example device according to various example embodiments.

As illustrated in FIG. 9, the device 100 for generating driving assistance information according to an example embodiment may include a controller (e.g., including processing circuitry) 130 and a sensing unit (e.g., including sensors/sensing circuitry) 140. However, not all of the components illustrated in FIG. 9 are indispensable components of the device 100. The device 100 may be implemented using more components than the components illustrated in FIG. 9, or the device 100 may be implemented using less components than those illustrated in FIG. 9.

For example, as illustrated in FIG. 10, the device 100 according to an example embodiment may further include a user input unit (e.g., including input circuitry) 110, an output unit (e.g., including output circuitry) 120, a communication unit (e.g., including communication circuitry) 150, an AN input unit (e.g., including AN input circuitry) 160, and a memory 170, in addition to the controller 130 and the sensing unit 140.

The user input unit 110 may include various circuitry for a user of the device 100 (for example, a driver) to input data for controlling the device 100. For example, the user input unit 110 may include various input circuitry, such as, for example, and without limitation, a key pad, a dome switch, a touch pad (a contact type capacitance type, a pressure type resistive type, an infrared ray detection type, a surface ultrasonic wave conduction type, a tension measuring method, a piezo effect method, etc.), a jog wheel, a jog switch, and the like but is not limited thereto.

In an embodiment, the user input 110 may receive a user input and execute an application. For example, the user input unit 110 may receive the user input and display running history information of a vehicle.

The output unit 120 may include various output circuitry and output an audio signal, a video signal, or a vibration signal, and may include, for example, and without limitation, a display unit 121, an acoustic output unit 122, and a vibration motor 123.

The display unit 121 may display and output information processed by the device 100. For example, the display unit 121 may display a video signal or an image signal generated based on a risk level of the driver. Also, for example, the display unit 121 may display the running history information of the vehicle generated using information about a current state of the vehicle which is sensed while the vehicle is running.

The audio output unit 122 may include various circuitry to output audio data received from the communication unit 150 or stored in the memory 170. Also, the sound output unit 122 may output sound signals related to functions (e.g., call signal reception sound, message reception sound, and notification sound) performed in the device 100. For example, the sound output unit 122 may output an audio signal generated based on the risk level of the driver.

The controller 130 may include various processing circuitry and may typically control an overall operation of the device 100. For example, the controller 130 may generally control the user input unit 110, the output unit 120, the sensing unit 140, the communication unit 150, the A/V input unit 160, etc. by executing programs stored in the memory 170. In addition, the controller 130 may perform functions of the device 100 illustrated in FIGS. 1 through 8 by executing the programs stored in the memory 170. The controller 130 may include at least one processor. The controller 130 may include a plurality of processors, or may include one processor in an integrated form, depending on its function and role.

In an embodiment, the controller 130 may recognize a running pattern of the vehicle based on the information about the current state of the vehicle which is sensed while the vehicle is running. For example, the controller 130 may recognize the running pattern of the vehicle based on information obtained from sensing as the vehicle runs on a highway. Further, for example, the controller 130 may recognize the running pattern of the vehicle based on information obtained from sensing by a device of the user located in the vehicle.

In an embodiment, the controller 130 may determine a current status of the driver based on the running pattern of the vehicle. For example, the controller 130 may determine the current state of the driver corresponding to the running pattern of the vehicle according to a model generated by the learning.

Further, in an embodiment, the controller 130 may generate a notification signal based on the risk level of the driver determined according to the determined current status of the driver. For example, the controller 130 may further consider at least one of the information obtained from the vehicle and biometric information of the driver obtained from the device of the user to determine the risk level of the driver. For example, the controller 130 may generate a notification signal when the risk level of the driver is greater than a threshold value.

In an embodiment, the controller 130 may control the communication unit 150 to transmit a notification signal generated for operating a module installed in the vehicle to the module installed in the vehicle. For example, if the controller 130 determines that the risk level of the driver is greater than the threshold value, the controller 130 may control the communication unit 130 to transmit the generated notification signal to a steering wheel, a chair of a driver's seat, a seat belt, and/or a window of the vehicle. If the controller 130 determines that the risk level of the driver is less than the threshold value, the controller 130 may control the communication unit 150 not to immediately transmit the notification signal to the module installed in the vehicle.

The sensing unit 140 may sense a state of the device 100, a status of the user, or a state around the device 100 and may transmit information obtained from the sensing to the controller 130.

The sensing unit 140 may include various sensors or sensing circuitry, such as, for example, and without limitation, at least one of a gravity sensor 141, an acceleration sensor 142, a gyroscope sensor 143, an infrared sensor 144, an IMU sensor 145, a position sensor 146 (for example, a GPS), an atmospheric pressure sensor 147, a proximity sensor 148, and an RGB sensor 149 but is not limited thereto. A function of each sensor may be intuitively deduced from the name by those of ordinary skill in the art, and thus a detailed description thereof will be omitted here.

The communication unit 150 may include various communication circuitry that allow the device 100 to communicate with an external device and a server. For example, the external device may be a module (e.g., a steering wheel, a chair in a driver's seat, or a seat belt) installed in the vehicle, and may be a computing device such as the device 100 but is not limited thereto. For example, the communication unit 150 may include various communication circuitry, such as, for example, and without limitation, a short-range wireless communication unit 151, a mobile communication unit 152, and a broadcast reception unit 153.

The short-range wireless communication unit 151 may include various short-range communication circuitry, such as, for example, and without limitation, a Bluetooth communication unit, a BLE (Bluetooth Low Energy) communication unit, a near field communication unit, a WLAN communication unit, a Zigbee communication unit, an IrDA (infrared data association) communication unit, a WFD (Wi-Fi Direct) communication unit, an UWB (ultra wideband) communication unit, an Ant+communication unit, and the like but is not limited thereto.

The mobile communication unit 152 may transmit and receive a radio signal to and from at least one of a base station, an external terminal, and a server over a mobile communication network. Here, the wireless signal may include various types of data depending on a voice call signal, a video call signal, or text/multimedia message transmission/reception.

The broadcast receiving unit 153 may receive broadcast signals and/or broadcast-related information from outside via a broadcast channel. The broadcast channel may include a satellite channel and a terrestrial channel. The device 100 may not include the broadcast receiver 153 according to an implementation example.

In an embodiment, the communication unit 150 may transmit a notification signal generated for operating a module installed in the vehicle to a module installed in the vehicle. For example, the communication unit 150 may transmit a notification signal for vibrating the chair of the driver's seat to the chair of the driver's seat.

In addition, in an embodiment, the communication unit 150 may communicate with other devices of the vehicle and the driver in order to receive the information obtained from the vehicle and the biometric information of the driver obtained from another device (e.g., a wearable device).

The A/V (audio/video) input unit 160 is for inputting an audio signal or a video signal, and may include a camera 161 and a microphone 162. The camera 161 may obtain an image frame such as a still image or a moving image through an image sensor in a video communication mode or a photographing mode. An image captured through the image sensor may be processed through the controller 130 or a separate image processing unit (not shown).

The microphone 162 may receive an external acoustic signal and process the external acoustic signal as electrical voice data. For example, the microphone 162 may receive acoustic signals from an external device or the user. The microphone 162 may use various noise elimination algorithms to remove noise generated in receiving the external acoustic signal.

The memory 170 may store a program for processing and controlling the controller 130 and may store data input to the device 100 or output from the device 100.

The memory 170 may include at least one type of storage medium among a flash memory type, a hard disk type, a multimedia card micro type, a card type memory (for example, SD or XD memory), a RAM (random access memory), SRAM (static random access memory), ROM (read only memory), EEPROM (electrically erasable programmable read-only memory), PROM (programmable read-only memory), and an optical disc.

The programs stored in the memory 170 may be classified into a plurality of modules according to their functions, for example, a UI module 171, a touch screen module 172, a notification module 173, or the like.

The UI module 171 may provide a specialized UI, a GUI, and the like that are synchronized with the device 100 for each application. The touch screen module 172 may sense a touch gesture on a touch screen of the user and may transmit information on the touch gesture to the controller 130. The touch screen module 172 according to one embodiment may recognize and analyze a touch code. The touch screen module 172 may be configured as separate hardware including a controller.

The notification module 173 may generate a signal for notifying an occurrence of an event of the device 100. Examples of events generated in the device 100 may include call signal reception, message reception, key signal input, schedule notification, and the like. The notification module 173 may output a notification signal in the form of a video signal through the display unit 121 or may output a notification signal in the form of an audio signal through the sound output unit 122, and may output a notification signal in the form of a vibration signal.

FIG. 11 is a block diagram illustrating an example controller according to an example embodiment.

Referring to FIG. 11, the controller 130 according to some embodiments may include a data learning unit (e.g., including processing circuitry and/or program elements) 131 and a data recognition unit (e.g., including processing circuitry and/or program elements) 132.

The data learning unit 131 may learn a reference for determining whether a vehicle is running on a highway and a reference for determining a risk level of a driver. The data learning unit 131 may learn what data to use to determine whether the vehicle is running on the highway or how to determine whether the vehicle is running on the highway by using the data. Further, the data learning unit 131 may learn what data to use to determine the risk level of the driver and how to determine the risk level of the driver by using the data. The data learning unit 131 may obtain data to be used for learning and apply the obtained data to a data recognition model that will be described later to determine the reference for determining whether the vehicle is running on the highway and the reference for determining the risk level of the driver.

In an embodiment, the data to be used for learning may be the information about a current state of the vehicle which is sensed while the vehicle is running. Further, in an embodiment, highway information, brain wave information of the driver, dangerous driving pattern information of the driver, and the like may be used together with learning.

FIGS. 1 through 10 illustrate operations of obtaining the information about the current state of the vehicle which is sensed while the vehicle is running, determining whether the vehicle is running on the highway, determining the running pattern of the vehicle, determining the current status of the driver, determining a location of the device 100, etc. which are separately performed, but the present disclosure is not limited thereto. Two or more of operations of obtaining the information about the current state of the vehicle which is sensed while the vehicle is running, determining whether the vehicle is running on the highway, determining the running pattern of the vehicle, determining the current status of the driver, determining the location of the device 100, etc. may be performed based on learning according to a preset reference.

Based on the data, the data recognition unit 132 may determine whether the vehicle is running on the highway and may determine the risk level of the driver. The data recognition unit 132 may use the learned data recognition model to determine from predetermined data whether the vehicle is running on the highway and determine the risk level of the driver. The data recognition unit 132 may obtain predetermined data in accordance with a preset reference by learning and use the data recognition model with the obtained data as an input value to determine that the vehicle is running on the highway based on the predetermined data. Also, the data recognition unit 132 may obtain predetermined data in accordance with a preset reference by learning and use the obtained data as an input value to use the data recognition model to calculate the risk level of the driver based on the predetermined data. Further, a resultant value output by the data recognition model with the obtained data as an input value may be used to update the data recognition model. At least one of the data learning unit 131 and the data recognizing unit 132 may be manufactured in the form of at least one hardware chip and mounted on an electronic device. For example, at least one of the data learning unit 131 and the data recognition unit 132 may be manufactured in the form of a dedicated hardware chip for artificial intelligence (Al) or may be manufactured as part of an existing general purpose processor (e.g. a CPU or an application processor) or a graphics processor (e.g., a GPU) and may be mounted on various electronic devices described above.

In this case, the data learning unit 131 and the data recognizing unit 132 may be mounted on one device or may be mounted on separate devices. For example, one of the data learning unit 131 and the data recognizing unit 132 may be included in the device 100, and the other may be included in the server 1400. The data learning unit 131 and the data recognition unit 132 may provide model information constructed by the data learning unit 131 to the data recognition unit 132 via wire or wirelessly. Data input to the data recognition unit 132 may be provided to the data learning unit 131 as additional learning data.

Meanwhile, at least one of the data learning unit 131 and the data recognition unit 132 may be implemented as a software module. When at least one of the data learning unit 131 and the data recognition unit 132 is implemented as a software module (or a program module including program elements including an instruction), the software module may be stored in a non-transitory computer readable recording medium. Further, in this case, at least one software module may be provided by an operating system (OS) or by a predetermined application. Alternatively, some of the at least one software module may be provided by an operating system (OS), and others may be provided by a predetermined application.

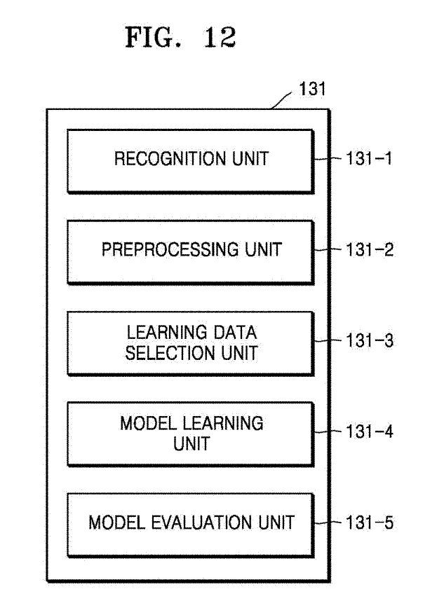

FIG. 12 is a block diagram illustrating an example data learning unit according to an example embodiment.

Referring to FIG. 12, the data learning unit 131 according to some embodiments may include a data acquisition unit (e.g., including processing circuitry and/or program elements) 131-1, a preprocessing unit (e.g., including processing circuitry and/or program elements) 131-2, a learning data selection unit (e.g., including processing circuitry and/or program elements) 131-3, a model learning unit (e.g., including processing circuitry and/or program elements) 131-4, and a model evaluation unit (e.g., including processing circuitry and/or program elements) 131-5.

The data acquisition unit 131-1 may obtain data necessary for obtaining information about a current state of a vehicle which is sensed while the vehicle is running, determine whether the vehicle is running on a highway, determine a running pattern of the vehicle, determine a current status of a driver, determine a risk level of the driver, and determine a location of the device 100. The data acquisition unit 131-1 may obtain data necessary learning for obtaining the information about the current state of the vehicle which is sensed while the vehicle is running, determine whether the vehicle is running on the highway, determine the running pattern of the vehicle, determine the current status of the driver, determine the risk level of the driver, and determine the location of the device 100.

For example, the data acquisition unit 131-1 may obtain sensing data and the like. For example, the data acquisition unit 131-1 may receive data via the sensing unit 140 (for example, the IMU sensor 145 and the position sensor 146) of the device 100. Alternatively, the data acquisition unit 131-1 may obtain data via an external device (for example, a module installed in the vehicle or another device of the driver) communicating with the device 100. Alternatively, the data acquisition unit 131-1 may obtain data through the server 1400 that communicates with the device 100.

The preprocessing unit 131-2 may pre-process the obtained data so that the obtained data may be used for learning to determine whether the vehicle is running on the highway and for learning the risk level of the driver. The preprocessing unit 131-2 may process the obtained data into a preset format so that the model learning unit 131-4 may use the obtained data for learning to determine whether the vehicle is running on the highway and for learning the risk level of the driver.

In an embodiment, the preprocessing unit 131-2 may arrange the obtained data in rows for each source of the obtained data and process the data into an image format.

The learning data selection unit 131-3 may select data required for learning from the preprocessed data. The selected data may be provided to the model learning unit 131-4. The learning data selection unit 131-3 may select data required for learning from the preprocessed data according to a preset reference for determining whether the vehicle is running on the highway and a preset reference for determining the risk level of the driver. The learning data selection unit 131-3 may also select data according to a preset reference by learning by the model learning unit 131-4 which will be described later.

The model learning unit 131-4 may learn a reference on how to determine whether the vehicle is running on the highway and how to determine the risk level of the driver based on learning data. Also, the model learning unit 131-4 may learn a reference as to what learning data should be used to determine whether the vehicle is running on the highway. Also, the model learning unit 131-4 may learn a reference as to which learning data should be used in order to determine the risk level of the driver.

Also, the model learning unit 131-4 may learn a data recognition model used for determining whether the vehicle is running on the highway and the risk level of the driver using the learning data. In this case, the data recognition model may be a pre-built model. For example, the data recognition model may be a pre-built model that receives basic learning data (e.g., vehicle sample acceleration data, etc.).

The data recognition model may be constructed considering an application field of the recognition model, a purpose of learning, or computer performance of a device. The data recognition model may be, for example, a model based on a neural network. For example, a model such as a deep neural network (DNN), a recurrent neural network (RNN), and a bidirectional recurrent deep neural network (BRDNN) may be used as a data recognition model, but is not limited thereto.

According to various example embodiments, when a plurality of data recognition models that are built in advance are present, the model learning unit 131-4 may determine a data recognition model to learn a data recognition model having a high relation between input learning data and basic learning data. In this case, the basic learning data may be pre-classified according to a type of data, and the data recognition model may be pre-built for each data type. For example, the basic learning data may be pre-classified by various references such as an area where the learning data is generated, a time at which the learning data is generated, a size of the learning data, a genre of the learning data, a creator of the learning data, a type of an object inside the learning data, etc.

The model learning unit 131-4 may also learn a data recognition model using, for example, a learning algorithm including an error back-propagation method or a gradient descent method

Also, the model learning unit 131-4 may learn the data recognition model through supervised learning using, for example, learning data as an input value. The model learning unit 131-4 may learn the data recognition model through unsupervised learning that finds reference for determining whether the vehicle is running on the highway and determining the risk level of the driver by self learning a type of data necessary for determining whether the vehicle is running on the highway and determining the risk level of the driver without any guidance. Further, the model learning unit 131-4 may learn the data recognition model through reinforcement learning using, for example, feedback on a result of determining whether the vehicle according to learning is driving on the highway and a result of determining the risk level of the driver are correct.

Further, when the data recognition model is learned, the model learning unit 131-4 may store the learned data recognition model. In this case, the model learning unit 131-4 may store the learned data recognition model in the memory of the device 100 including the data recognition unit 132. Alternatively, the model learning unit 131-4 may store the learned data recognition model in the memory of the device 100 including the data recognition unit 132 that will be described later. Alternatively, the model learning unit 131-4 may store the learned data recognition model in the memory of the server 1400 connected to the device 100 via a wired or wireless network.

In this case, the memory in which the learned data recognition model is stored may store, for example, instructions or data associated with at least one other component of the device 100 together. The memory may also store software and/or programs. The program may include, for example, a kernel, middleware, an application programming interface (API), and/or an application program (or “application”).

The model evaluating unit 131-5 may input evaluation data to the data recognition model, and when a recognition result output from the evaluation data does not satisfy a predetermined reference, the model evaluating unit 131-5 may instruct the model learning unit 131-4 to learn again. In this case, the evaluation data may be preset data for evaluating the data recognition model.

For example, when the number or ratio of evaluation data in which the recognition result is not correct is greater than a preset threshold value, among recognition results of the learned data recognition model for the evaluation data, the model evaluation unit 131-5 may evaluate the recognition result output from the evaluation as unsatisfactory. For example, when the predetermined reference is defined as a ratio of 2%, when the learned data recognition model outputs an incorrect recognition result for evaluation data exceeding 20 among a total of 1000 pieces of evaluation data, the model evaluation unit 131-5 may evaluate that the learned data recognition model is not suitable.

On the other hand, when a plurality of learned data recognition models are present, the model evaluation unit 131-5 may evaluate whether each of the learned recognition models satisfies a predetermined reference, and may determine a model satisfying the predetermined reference as a final data recognition model. In this case, when a plurality of models satisfying the predetermined reference are present, the model evaluating section 131-5 may determine any one or a predetermined number of models preset in descending order of evaluation scores as the final data recognition model.

On the other hand, at least one of the data acquisition unit 131-1, the preprocessing unit 131-2, the learning data selection unit 131-3, the model learning unit 131-4, and the model evaluation unit 131-5 may be mounted in the form of at least one hardware chip and mounted on a device. For example, at least one of the data acquisition unit 131-1, the preprocessing unit 131-2, the learning data selection unit 131-3, the model learning unit 131-4, and the model evaluation unit 131-5 may be manufactured in the form of a dedicated hardware chip for artificial intelligence (Al) or may be manufactured as part of an existing general purpose processor (e.g. a CPU or an application processor) or a graphics processor (e.g., a GPU) and may be mounted on various electronic devices described above.

The data acquisition unit 131-1, the preprocessing unit 131-2, the learning data selection unit 131-3, the model learning unit 131-4, and the model evaluation unit 131-5 may be mounted one device or on separate devices. For example, some of the data acquisition unit 131-1, the preprocessing unit 131-2, the learning data selection unit 131-3, the model learning unit 131-4, and the model evaluation unit 131-5 may be included in the device and the others may be included in the server 1400.

At least one of the data acquisition unit 131-1, the preprocessing unit 131-2, the learning data selection unit 131-3, the model learning unit 131-4, and the model evaluation unit 131-5 may be implemented as a software module. When at least one of the data acquisition unit 131-1, the preprocessing unit 131-2, the learning data selection unit 131-3, the model learning unit 131-4, and the model evaluation unit 131-5 is implemented as a software module (or a program module including an instruction), the software module may be stored in a non-transitory computer readable media. Further, in this case, at least one software module may be provided by an operating system (OS) or by a predetermined application. Alternatively, some of the at least one software module may be provided by an operating system (OS), and others may be provided by a predetermined application.

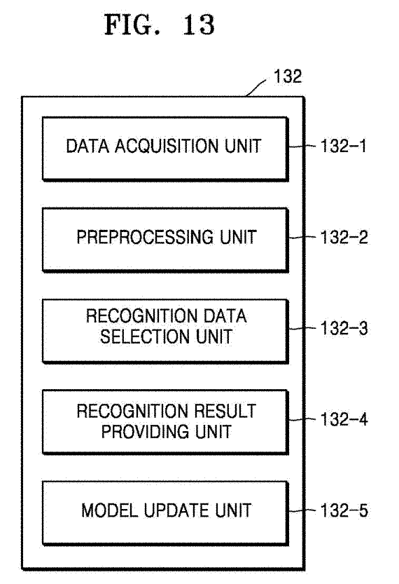

FIG. 13 is a block diagram illustrating an example data recognition unit according to an example embodiment.

Referring to FIG. 13, the data recognition unit 132 according to some embodiments may include a data acquisition unit (e.g., including processing circuitry and/or program elements) 132-1, a preprocessing unit (e.g., including processing circuitry and/or program elements) 132-2, a recognition data selection unit (e.g., including processing circuitry and/or program elements) 132-3, a recognition result providing unit (e.g., including processing circuitry and/or program elements) 132-4, and a model update unit (e.g., including processing circuitry and/or program elements) 132-5.

The data acquiring unit 132-1 may obtain information about a current state of a vehicle which is sensed while the vehicle is running and may obtain data necessary for determining whether the vehicle is running on a highway, determining a running pattern of the vehicle, determining a current status of a driver, determining a risk level of the driver, and determining a location of the device 100. The preprocessing unit 132-2 may obtain the information about the current state of the vehicle which is sensed while the vehicle is running and preprocess the obtained data so that the data obtained to determine whether the vehicle is running on the highway, determine the running pattern of the vehicle, determine the current status of the driver, determine the risk level of the driver, and determine the location of the device 100 may be used. The preprocessing unit 132-2 may process the obtained data in a preset format so that the recognition result providing unit 132-4 which will be described later may obtain information about the current state of the vehicle which is sensed while the vehicle is running and may use the data obtained to determine whether the vehicle is running on the highway, determine the running pattern of the vehicle, determine the current status of the driver, determine the risk level of the driver, and determine the location of the device 100.

The recognition data selection unit 132-3 may obtain the information about the current state of the vehicle which is sensed while the vehicle is running and select data necessary for determining whether the vehicle is running on the highway, determining the running pattern of the vehicle, determining the current status of the driver, determining the risk level of the driver, and determining the location of the device 100 from the preprocessed data. The selected data may be provided to the recognition result provider 132-4. The recognition data selection unit 132-3 may select some or all of the preprocessed data according to a preset reference for determining whether the vehicle is running on the highway. In addition, the recognition data selection unit 132-3 may select some or all of the preprocessed data according to a preset reference for determining the risk level of the driver. The recognition data selection unit 132-3 may also select data according to a preset reference by learning by the model learning unit 131-4 described above.

The recognition result provider 132-4 may determine whether the vehicle is running on the highway by applying the selected data to a data recognition model and may determine the risk level of the driver. The recognition result providing unit 132-4 may provide a recognition result according to a data recognition purpose. The recognition result providing unit 132-4 may apply the selected data to the data recognition model by using the data selected by the recognition data selecting unit 132-3 as an input value. Further, the recognition result may be determined by the data recognition model.

For example, a recognition result of the information about the current state of the vehicle which is sensed while the vehicle is running may be provided as text, voice, moving image, image, numerical value or command (for example, application execution command, module function execution command, etc.). The recognition result providing unit 132-4 may apply the information about the current state of the vehicle which is sensed while the vehicle is running to the data recognition model to provide the recognition result of the information about the current state of the vehicle while the vehicle is running. For example, the recognition result may be that the vehicle is running on a highway, the risk level of the driver is 8, and so on. For example, the recognition result providing unit 132-4 may provide a recognition result that the vehicle is running on the highway as text, voice, moving picture, image, numerical value, or command, etc. Also, for example, the recognition result providing unit 132-4 may provide a recognition result of the risk level of the driver as text, voice, moving image, image, numerical value, or command, etc. The model updating unit 132-5 may update the data recognition model based on an evaluation of the recognition result provided by the recognition result providing unit 132-4. For example, the model updating unit 132-5 may provide the model learning unit 131-4 with the recognition result provided by the recognition result providing unit 132-4 so that the model learning unit 131-4 may update the data recognition model.

At least one of the data acquisition unit 132-1, the preprocessing unit 132-2, the recognition data selection unit 132-3, the recognition result provision unit 132-4, and the model update unit 132-5 of the data recognition unit 132 may be fabricated in at least one hardware chip form and mounted on a device. For example, at least one of the data acquisition unit 132-1, the preprocessing unit 132-2, the recognition data selection unit 132-3, the recognition result provision unit 132-4, and the model update unit 132-5 may be manufactured in the form of a dedicated hardware chip for artificial intelligence (Al) or may be manufactured as part of an existing general purpose processor (e.g. a CPU or an application processor) or a graphics processor (e.g., a GPU) and may be mounted on various electronic devices described above.

The data acquisition unit 132-1, the preprocessing unit 132-2, the recognition data selection unit 132-3, the recognition result provision unit 132-4, and the model update unit 132-5 may be mounted on one device or on separate devices. For example, some of the data acquisition unit 132-1, the preprocessing unit 132-2, the recognition data selection unit 132-3, the recognition result provision unit 132-4, and the model update unit 132-5 may be included in the device, and the others may be included in the server 1400.

At least one of the data acquisition unit 132-1, the preprocessing unit 132-2, the recognition data selection unit 132-3, the recognition result provision unit 132-4, and the model update unit 132-5 may be implemented as a software module. When at least one of the data acquisition unit 132-1, the preprocessing unit 132-2, the recognition data selection unit 132-3, the recognition result providing unit 132-4, and the model updating unit 132-5 is implemented as a software module (or a program module including an instruction), the software module may be stored in a non-transitory computer readable media. Further, in this case, at least one software module may be provided by an operating system (OS) or by a predetermined application. Alternatively, some of the at least one software module may be provided by an OS, and others may be provided by a predetermined application.

FIG. 14 is a diagram illustrating an example in which the device 100 and the server 1400 are synchronized with each other and learn and recognize data according to an example embodiment.

Referring to FIG. 14, the server 1400 may learn a reference for determining whether a vehicle is running on a highway and a reference for determining a risk level of a driver. The device 100 may determine whether the vehicle is running on the highway based on a learning result by the server 1400 and determine the risk level of the driver.

In this case, a model learning unit 1434 of the server 1400 may perform a function of the data learning unit 131 illustrated in FIG. 12. The model learning unit 1434 of the server 1400 may determine whether the vehicle is running on the highway and may learn what data to use to determine the risk level of the drive and the reference as to how to determine whether the vehicle is running on the highway and the reference as to how to determine the risk level of the driver by using thee data. The model learning unit 1434 may obtain data to be used for learning and apply the obtained data to a data recognition model that will be described later to learn the reference for determining whether the vehicle is running on the highway and the reference for determining the risk level of the driver.

The recognition result providing unit 132-4 of the device 100 may apply the data selected by the recognition data selecting unit 132-3 to a data recognition model generated by the server 1400 to determine whether the vehicle is running on the highway and the risk level of the driver. For example, the recognition result providing unit 132-4 may transmit the data selected by the recognition data selecting unit 132-3 to the server 1400 and may request the server 1400 to apply the data selected by the recognition data selecting unit 132-3 to the data recognition model and t determine whether the vehicle is running on the highway and may request the server 1400 to determine the risk level of the driver. The recognition result providing unit 132-4 may receive from the server 1400 information on whether or not the vehicle is running on the highway determined by the server 1400. In addition, the recognition result providing unit 132-4 may receive from the server 1400 information on the risk level of the driver determined by the server 1400.

Alternatively, the recognition result providing unit 132-4 of the device 100 may receive the recognition model generated by the server 1400 from the server 1400, and determine whether the vehicle is running on the highway and the risk level of the driver using the received recognition model. In this case, the recognition result providing unit 132-4 of the device 100 may apply the data selected by the recognition data selecting unit 132-3 to the data recognition model received from the server 1400 to determine whether the vehicle is running on the highway and the risk level of the driver.

Some embodiments may be embodied as a non-transitory computer-readable recording medium including instructions executable by a computer. Examples of the non-transitory computer-readable recording medium may be a program module. The non-transitory computer-readable recording medium may be a medium accessed by a computer and includes a volatile medium, a non-volatile medium, a removable medium and a non-removable medium. Also, the non-transitory computer-readable recording medium may include a computer storage medium and a communication medium. The non-transitory computer-readable recording medium may include a volatile medium, a non-volatile medium, a removable medium and a non-removable medium that are implemented by an arbitrary method or technology for storing information such as computer-readable instructions, data structures, program modules, or other data. The communication medium includes computer-readable instructions, data structures, program modules, data, and a transmission mechanism and includes an arbitrary information transmission medium.

Also, throughout the specification, the term “unit” may be a hardware component such as a processor or a circuit, and/or a software component driven by a hardware component such as a processor.

It will be understood by those skilled in the art that the foregoing description of the present disclosure is for illustrative purposes only and that those skilled in the art may easily understand that the present disclosure may be easily modified into other specific forms without changing the technical ideas or essential features of the present disclosure will be. It is therefore to be understood that the above-described embodiments are illustrative in all aspects and not restrictive. For example, each component described as a single entity may be distributed and implemented, and components described as being distributed may also be implemented in a combined form.

It should be understood that embodiments described herein should be considered in a descriptive sense only and not for purposes of limitation. Descriptions of features or aspects within each embodiment should typically be considered as available for other similar features or aspects in other embodiments.

While various example embodiments have been described with reference to the figures, it will be understood by those of ordinary skill in the art that various changes in form and details may be made therein without departing from the spirit and scope as defined by the following claims.

What is claimed is:

1. A device comprising:
a sensor configured to sense a current state of a vehicle while the vehicle is running; and
a controller configured to recognize a running pattern of the vehicle based on information obtained by the sensor, to determine a current status of a driver of the vehicle based on the running pattern of the vehicle, and to generate a notification signal based on a risk level of the driver determined based on the determined current status of the driver.

2. The device of claim 1, wherein the controller is configured to recognize the running pattern based on information obtained by the sensor as the vehicle runs on a highway.

3. The device of claim 1, wherein the controller is configured to recognize the running pattern based on information obtained by the sensor of a device of the driver located in the vehicle.

4. The device of claim 1, wherein the controller is configured to determine the current status of the driver corresponding to the running pattern based on a model generated by learning.

5. The device of claim 1, wherein the controller is configured to generate the notification signal when the risk level of the driver is greater than a threshold value.

6. The device of claim 1, wherein the controller is configured to determine the risk level of the driver based at least one of: information obtained from the vehicle and biometrics information of the driver obtained from a device of the driver.

7. The device of claim 1, wherein the notification signal comprises at least one of: a sound, an image, and a vibration.

8. The device of claim 1, further comprising: a communication unit comprising communication circuitry configured to transmit the notification signal to operate a module installed in the vehicle.

9. The device of claim 1, further comprising: a display configured to display running history information of the vehicle generated using information obtained by the sensor.

10. A method of generating running assistance information comprising:
recognizing a running pattern of a vehicle based on information about a current state of the vehicle which is sensed while the vehicle is running;
determining a current status of a driver of the vehicle based on the running pattern of the vehicle; and
generating a notification signal based on a risk level of the driver determined based on the determined current status of the driver.

11. The method of claim 10, wherein the recognizing comprises: recognizing the running pattern based on information obtained from sensing as the vehicle runs on a highway.

12. The method of claim 10, wherein the recognizing comprises: recognizing the running pattern based on information obtained from sensing by a device of the driver located in the vehicle.

13. The method of claim 10, wherein the determining comprises: determining the current status of the driver corresponding to the running pattern based on a model generated by learning.

14. The method of claim 10, wherein the generating comprises: generating the notification signal when the risk level of the driver is greater than a threshold value.

15. The method of claim 10, wherein the generating comprises: determining the risk level of the driver based on at least one of: information obtained from the vehicle and biometrics information of the driver obtained from a device of the driver.

16. The method of claim 10, wherein the notification signal comprises at least one of: a sound, an image, and a vibration.

17. The method of claim 10, further comprising: transmitting the notification signal to operate a module installed in the vehicle.

18. The method of claim 10, further comprising: displaying running history information of the vehicle generated using the information about the current state of the vehicle which is sensed while the vehicle is running.

19. A non-transitory computer readable recording medium having recorded thereon a program which, when executed by a computer, performs the method of claim 10.
